(19) United States
(12) Patent Application Publication
(10) Pub. No.: US 2015/0135674 A1
(43) Pub. Date: May 21, 2015

(54) PICKING DEVICE FOR MAIZE OR THE LIKE

(71) Applicant: Franz Schrattenecker, Eggerding (AT)

(72) Inventor: Franz Schrattenecker, Eggerding (AT)

(21) Appl. No.: 14/357,671

(22) PCT Filed: Nov. 12, 2012
(86) PCT No.: PCT/EP2012/004700

§ 371 Date: Sep. 2, 2014

(30) Foreign Application Priority Data
Nov. 11, 2011 (DE) 10 2011 118 074.4

(51) Int. Cl. A01D 45/02

(52) U.S. Cl. CPC A01D 45/021
USPC 56/94

(57) ABSTRACT

The invention relates to a picking device for maize or the like, comprising several picking units (1) which each have a picking gap (5) and a rotating cutting blade (2). In order to allow utilization of the material to be cut, the picking units (1) comprise at least one driver (10, 11) that rotates about a vertical axis (4).

The invention relates to a picking device for corn or the like and a combine-harvester with such picking device.

A picking device for corn or the like is known from DE 20 2005 003 236 U1. The picking device comprises several picking units which are arranged one beside the other and which each comprise a picking gap and a cutting knife which rotates about a substantially horizontal axis.

In the known picking devices, the cut and possibly chopped cutting material, for example the corn straw, is deposited on the ground disorderly, so that it is not possible to recycle this cutting material.

It is the object of the invention to propose a picking device of the type mentioned above, which provides for a recycling of the cutting material.

In accordance with the invention, this object is solved by the features of claim 1. The picking units comprise at least one driver which rotates about a substantially vertical axis. The driver is arranged below the picking gap. It sweeps over at least a part of the picking gap. By the drivers, the cut and possibly chopped cutting material can be deposited to form a swath. In this way, the cutting material can be picked up with a baling press or a similar device, so that it can be recycled.

Advantageous developments are described in the sub-claims.

Advantageously, the axis of rotation of the cutting knives corresponds with the axis of rotation of the drivers. The cutting knives and the driver or drivers can be attached to the same axle.

According to another advantageous development, the centrifugal circle of the cutting knives is greater than the centrifugal circle of the drivers. In this way, it can be ensured that with the progress of work first the cutting knives take action with respect to the plant and only thereafter the drivers. It can thereby be ensured that the drivers receive already cut and possibly chopped cutting material for processing. Centrifugal circle of the cutting knives is understood to be the circle described by the outer ends of the knives around the axis of rotation. The same applies for the drivers whose outer ends describe a centrifugal circle with a diameter about the axis of rotation of the drivers.

Advantageously, the cutting knives are arranged below the driver or drivers.

According to another advantageous development, several drivers are arranged one above the other. Preferably, at least two drivers are arranged one above the other. The drivers preferably have the same axis of rotation. They can have the same centrifugal circle.

According to another advantageous development, the drivers are formed as tines.

The drivers preferably are convexly curved in direction of rotation.

Another advantageous development is characterized in that a group of at least two adjacent drivers rotates in the same direction. In this way, the cutting material can be passed on from one driver to the next. This can be done repeatedly. With this arrangement it is possible to produce fewer and larger swaths.

According to another advantageous development, adjacent drivers rotate in opposite directions. In this way, it is also possible to produce fewer and larger swaths.

Another advantageous development is characterized in that another group of at least two adjacent drivers rotates in the same direction, which is opposite to the direction of rotation of the drivers of the first group. As a result, even fewer and even larger swaths can be produced.

The invention furthermore relates to a combine-harvester with a picking device according to the invention.

Exemplary embodiments of the invention will be explained in detail below with reference to the attached drawing, in which:

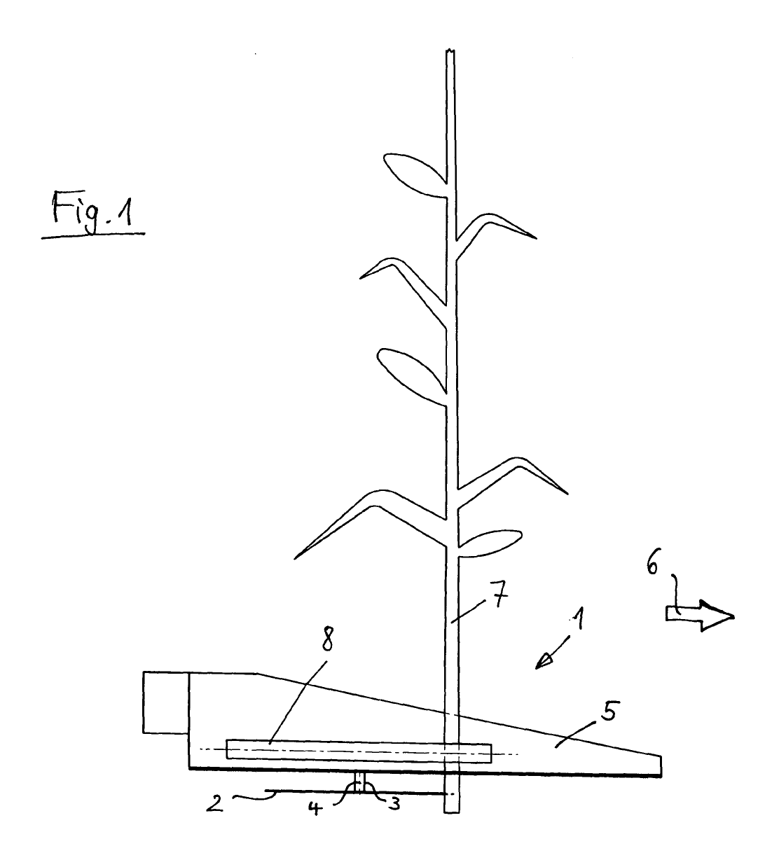

FIG. 1 shows a known picking device for corn in a side view,

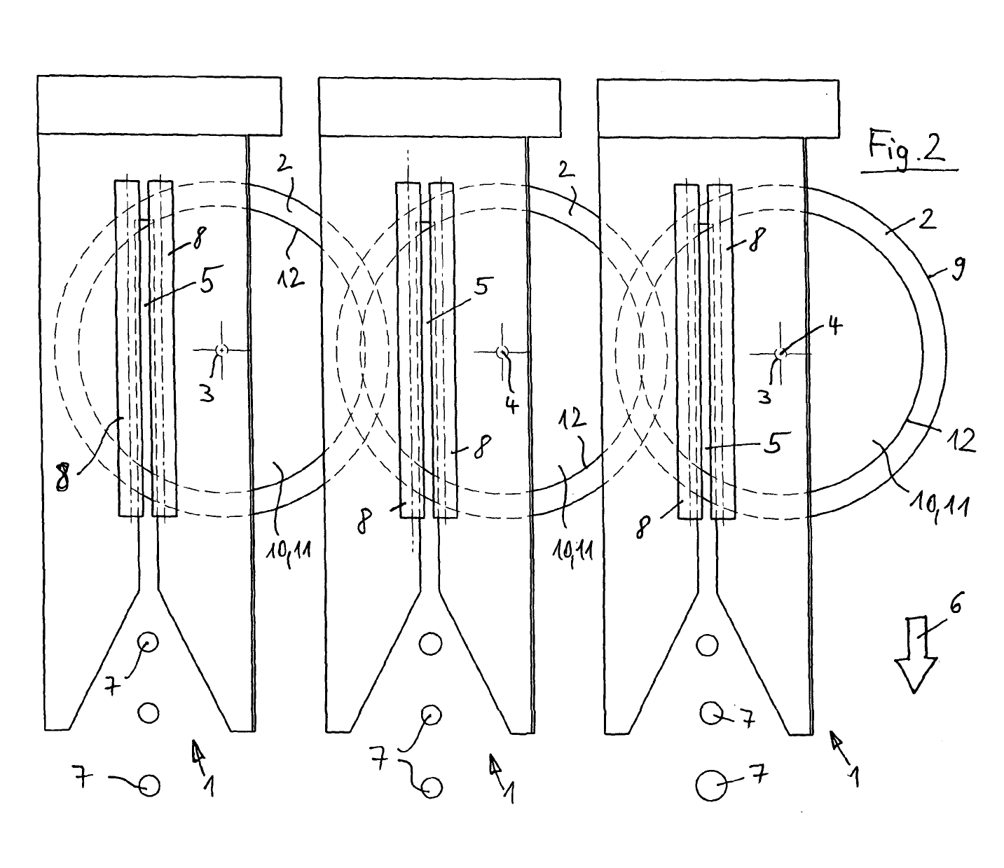

FIG. 2 shows a picking device according to the invention in a view from above,

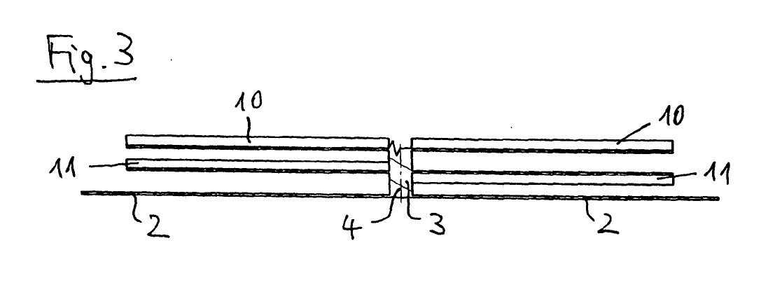

FIG. 3 shows the cutting knives and drivers of the picking device according to FIG. 2 in a side view,

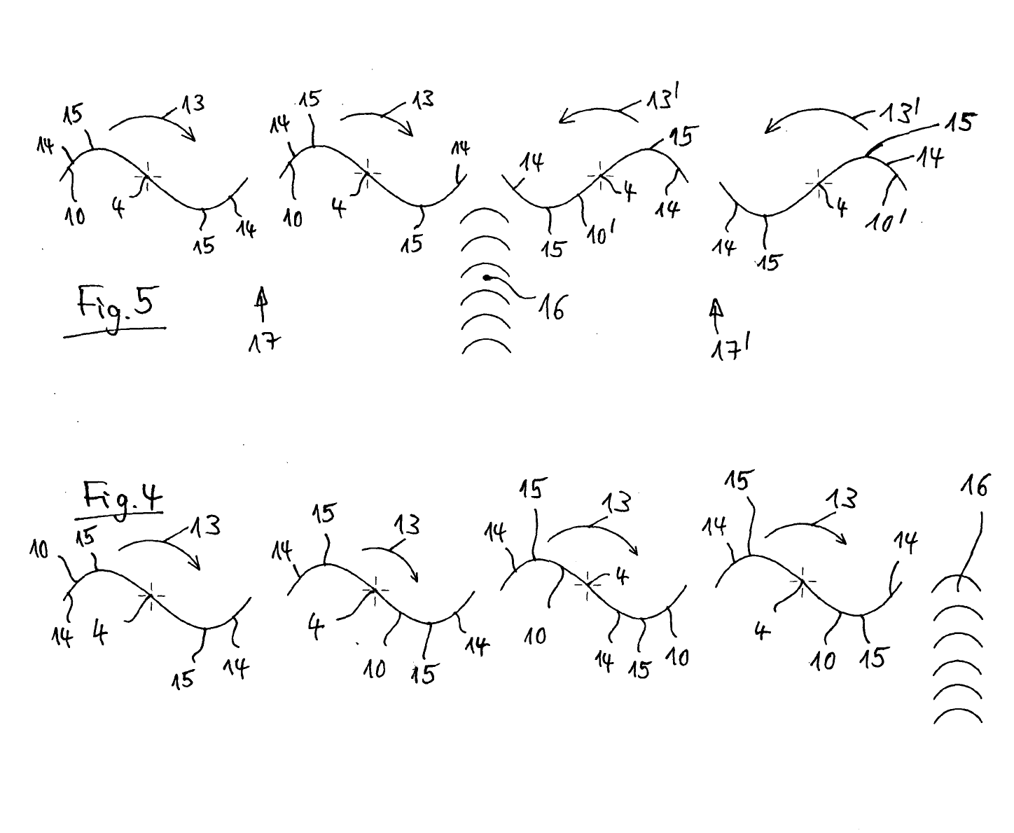

FIG. 4 shows the drivers of four picking units arranged one beside the other in a view from above, and

FIG. 5 shows the drivers of four other picking units arranged one beside the other in a view from above.

The known picking device shown in FIG. 1 comprises several picking units 1 which can be mounted on a combine-harvester (not shown in the drawing). The picking units 1 each comprise a cutting knife 2 which is attached to a vertical axle 3 and rotates about a vertical rotation axis 4. The picking units 1 furthermore each comprise a picking gap 5 which extends in the working direction 6 of the picking device. The working direction 6 is the direction of travel of the combine-harvester to which the picking device is attached. When the picking device moves in working direction 6, a corn plant 7 grown from the ground gets into the picking gap 5. It is cut off there by the cutting knife 2.

FIG. 2 shows a picking device according to the invention, in which the parts which correspond with the known picking device according to FIG. 1 are provided with the same reference numerals. On both sides of the picking gap 5, a draw-in roller 8 each is arranged. The draw-in rollers 8 extend in horizontal direction parallel to the working direction 6. They rotate in opposite directions.

The axles 3 of the cutting knives 2 are arranged at a lateral distance from the associated picking gap 5. The centrifugal circles 9 of the cutting knives 2 sweep over the associated picking gap 5.

Each picking unit 1 comprises two drivers 10, 11. The drivers 10, 11 are attached to the axle 3, to which the cutting knives 2 also are attached. The rotation axis 4 of the cutting knives 2 corresponds with the rotation axis 4 of the drivers 10, 11. The centrifugal circle 9 of the cutting knives 2 is greater than the centrifugal circle 12 of the drivers 10, 11. The centrifugal circles 12 of the drivers 10, 11 are of equal size. The centrifugal circles 9, 12 sweep over the picking gap 5.

As shown in FIG. 2, the centrifugal circles 9 of the cutting knives 2 of adjacent picking units 1 overlap each other. Furthermore, the centrifugal circles 12 of the drivers 10, 11 of adjacent picking units 1 overlap each other. To avoid collisions, the planes of the knives 2 and the drivers 10, 11 can be offset against each other in height. It is, however, also possible to synchronize the rotary movements of the cutting knives 2 and the drivers 10, 11 of adjacent picking units 1 with each other and to arrange the cutting knives 2 and drivers 10, 11 of adjacent picking units 1 such that they cannot collide with each other during their rotary movement.

As shown in FIG. 3, the cutting knives 2 are arranged below the drivers 10, 11. The drivers 10, 11 are arranged one above the other.

As shown in FIGS. 4 and 5, the drivers 10 (and also the drivers 11) are formed as tines. They are convexly curved in direction of rotation 13. Proceeding from the rotation axis 4, the drivers 10, 11 have two arms 14, which are offset to each other by 180° and which form a straight line in the region of the rotation axis 4. Each arm 14 has a convex curvature 15 in direction of rotation 13.

FIG. 4 shows a group of four adjacent drivers 10 which rotate in the same direction 13. The cutting material thereby is conveyed from one driver 10 to the adjacent driver 10 and from there passed on to the next up the last driver 10, beside which it is then deposited as swath 16.

FIG. 5 shows an embodiment in which adjacent drivers 10, 10′ rotate in opposite directions 13, 13′. The cutting material is deposited as swath 16 between the adjacent drivers 10, 10′.

Furthermore, in the embodiment according to FIG. 5 a first group 17 of two adjacent drivers 10 is present, which rotate in the same direction 13, i.e. in clockwise direction, and a further, second group 17′ of two adjacent drivers 10′. The adjacent drivers 10′ of the further group 17′ rotate in the same direction 13′, namely in anti-clockwise direction. The direction 13′, about which the drivers 10′ of the further group 17′ rotate, thus is opposite to the direction 13, about which the drivers 10 of the first group 17 rotate. By the adjacent drivers 10 and the adjacent drivers 10′ a swath 16 is deposited, which is greater than the swath that would be obtained when only one driver 10 and only one driver 10′ each was present.

The invention provides for recycling the cutting material, in particular corn straw, which is obtained during the harvesting operation. The fact is that swaths are produced by the device, which can be picked up with baling presses or the like. For this purpose, one or more rotating drivers are arranged horizontally below the picking unit, which in the centrifugal circle convey the material to the swath center by rotating in the same direction and overlapping each other.

1. A picking device for corn or the like with several picking units (1) which each comprise a picking gap (5) and at least one rotating cutting knife (2), wherein
the picking units (1) comprise at least one driver (10, 11) rotating about a vertical axis (4),

2. The picking unit according to claim 1, wherein the rotation axis (4) of the cutting knives (2) corresponds with the rotation axis (4) of the drivers (10, 11).

3. The picking device according to claim 1, wherein the centrifugal circle (9) of the cutting knives (2) is greater than the centrifugal circle (12) of the drivers (10, 11).

4. The picking device according to claim 1, wherein the cutting knives (2) are arranged below the driver or drivers (10, 11).

5. The picking device according to claim 1, wherein several drivers (10, 11) are arranged one above the other.

6. The picking device according to claim 1, wherein the drivers (10, 11) are formed as tines.

7. The picking device according to claim 1, wherein the drivers (10, 11) are convexly curved (15) in direction of rotation (13).

8. The picking device according to claim 1, wherein a group (17) of at least two adjacent drivers (10, 11) rotates in the same direction (13).

9. The picking device according to claim 1, wherein adjacent drivers (10, 10′) rotate in opposite directions (13, 13′).

10. The picking device according to claim 9, wherein a further group (17′) of at least two adjacent drivers (10′) rotates in the same direction (13′), which is opposite to the direction of rotation (13) of the drivers (10) of the first group (17).

11. A combine-harvester, characterized by a picking device according to claim 1.

12. The picking device according to claim 2, wherein the centrifugal circle (9) of the cutting knives (2) is greater than the centrifugal circle (12) of the drivers (10, 11).

13. The picking device according to claim 12, wherein the cutting knives (2) are arranged below the driver or drivers (10, 11)

14. The picking device according to claim 3, wherein the cutting knives (2) are arranged below the driver or drivers (10, 11).

15. The picking device according to claim 2, wherein the cutting knives (2) are arranged below the driver or drivers (10, 11).

16. The picking device according to claim 15, wherein several drivers (10, 11) are arranged one above the other.

17. The picking device according to claim 14, wherein several drivers (10, 11) are arranged one above the other.

18. The picking device according to claim 13, wherein several drivers (10, 11) are arranged one above the other.

19. The picking device according to claim 12, wherein several drivers (10, 11) are arranged one above the other.

20. The picking device according to claim 4, wherein several drivers (10, 11) are arranged one above the other.
